(19) United States
(12) Patent Application Publication
(10) Pub. No.: US 2025/0340362 A1
(43) Pub. Date: Nov. 6, 2025

(54) REFUSE VEHICLE WITH AUTONOMOUS FUNCTION USAGE TRACKING

(71) Applicant: Oshkosh Corporation, Oshkosh, WI (US)

(72) Inventor: Leo Van Kampen, Conestogo (CA)

(73) Assignee: Oshkosh Corporation, Oshkosh, WI (US)

(21) Appl. No.: 19/197,753

(22) Filed: May 2, 2025

Related U.S. Application Data
(60) Provisional application No. 63/642,038, filed on May 3, 2024.

(51) Int. Cl. B65F 3/02; G05B 13/02; G07C 5/10

(52) U.S. Cl. CPC B65F 3/02; G05B 13/0265; B65F 2003/0223; G07C 5/10

(57) ABSTRACT

A computer-implemented method involves receiving an auxiliary function dataset with parameters from a completed auxiliary function cycle, determining a cycle mode based on the parameters, and updating an auxiliary function tracker accordingly. The method is executed by one or more processors, enabling efficient tracking and management of auxiliary functions within a system. By analyzing the parameters of the completed cycle, the processors can identify the cycle mode and adjust the auxiliary function tracker to reflect the current state of the system.

### CROSS-REFERENCE TO RELATED PATENT APPLICATIONS

This application claims the benefit of and the priority to U.S. Provisional Patent Application No. 63/642,038, filed May 3, 2024, the entire disclosure of which is hereby incorporated by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

In some aspects, the techniques described herein relate to a computer-implemented method including: receiving, by one or more processors, an auxiliary function dataset including one or more parameters corresponding to a completed auxiliary function cycle; determining, by the one or more processors, a cycle mode of the completed auxiliary function cycle based at least in part on the one or more parameters; and updating, by the one or more processors, an auxiliary function tracker based at least in part on the determined cycle mode of the completed auxiliary function cycle.

In some aspects, the techniques described herein relate to a computer-implemented method, further including: transmitting, by the one or more processors to a user device, instructions to present for display the updated auxiliary function tracker on a display of the user device.

In some aspects, the techniques described herein relate to a computer-implemented method, further including receiving, by the one or more processors from a sensor array, the auxiliary function dataset, the auxiliary function dataset including an indication of a manual adjustment of an autonomous execution of the completed auxiliary function cycle.

In some aspects, the techniques described herein relate to a computer-implemented method, wherein the cycle mode includes one of an autonomous cycle, an autonomous cycle with manual interruption, an autonomous cycle with manual completion, and a manual cycle.

In some aspects, the techniques described herein relate to a computer-implemented method, wherein the one or more parameters include one or more of interruption type, completion status, error state flag, re-initiation, cart alignment, obstruction presence, manual override duration, control system confidence level, or learning mode.

In some aspects, the techniques described herein relate to a computer-implemented method, further including: generating, by the one or more processors, a heatmap based at least in part on the auxiliary function tracker, wherein the heatmap indicates geographic regions associated with completed auxiliary function cycles, and wherein the heatmap is segmented by cycle mode and the one or more parameters of the auxiliary function dataset.

In some aspects, the techniques described herein relate to a computer-implemented method, further including: training, by the one or more processors, a machine learning model using the auxiliary function dataset and the updated auxiliary function tracker, wherein the machine learning model is configured to predict a cycle mode of a future auxiliary function cycle based at least in part on the one or more parameters.

In some aspects, the techniques described herein relate to a refuse vehicle including: one or more processors; and a computer-readable, non-transitory storage medium including instructions that when executed by the one or more processors cause the one or more processors to execute a method including: receiving an auxiliary function dataset including one or more parameters corresponding to a completed auxiliary function cycle; determining a cycle mode of the completed auxiliary function cycle based at least in part on the one or more parameters; and updating an auxiliary function tracker based at least in part on the determined cycle mode of the completed auxiliary function cycle.

In some aspects, the techniques described herein relate to a refuse vehicle, the method further including: transmitting, by the one or more processors to a user device, instructions to present for display the updated auxiliary function tracker on a display of the user device.

In some aspects, the techniques described herein relate to a refuse vehicle, the method further including: receiving, by the one or more processors from a sensor array, the auxiliary function dataset, the auxiliary function dataset including an indication of a manual adjustment of an autonomous execution of the completed auxiliary function cycle.

In some aspects, the techniques described herein relate to a refuse vehicle, wherein the cycle mode includes one of an autonomous cycle, an autonomous cycle with manual interruption, an autonomous cycle with manual completion, and a manual cycle.

In some aspects, the techniques described herein relate to a refuse vehicle, wherein the one or more parameters include one or more of interruption type, completion status, error state flag, re-initiation, cart alignment, obstruction presence, manual override duration, control system confidence level, or learning mode.

In some aspects, the techniques described herein relate to a refuse vehicle, the method further including: generating, by the one or more processors, a heatmap based at least in part on the auxiliary function tracker, wherein the heatmap indicates geographic regions associated with completed auxiliary function cycles, and wherein the heatmap is segmented by cycle mode and the one or more parameters of the auxiliary function dataset.

In some aspects, the techniques described herein relate to a refuse vehicle, the method further including: training, by the one or more processors, a machine learning model using the auxiliary function dataset and the updated auxiliary function tracker, wherein the machine learning model is configured to predict a cycle mode of a future auxiliary function cycle based at least in part on the one or more parameters.

In some aspects, the techniques described herein relate to a computer-readable, non-transitory storage medium including instructions that when executed by one or more processors cause the one or more processors to execute a method including: receiving an auxiliary function dataset including one or more parameters corresponding to a completed auxiliary function cycle; determining a cycle mode of the completed auxiliary function cycle based at least in part on the one or more parameters; and updating an auxiliary function tracker based at least in part on the determined cycle mode of the completed auxiliary function cycle.

In some aspects, the techniques described herein relate to a computer-readable, non-transitory storage medium, the method further including: transmitting, by the one or more processors to a user device, instructions to present for display the updated auxiliary function tracker on a display of the user device.

In some aspects, the techniques described herein relate to a computer-readable, non-transitory storage medium, the method further including: receiving, by the one or more processors from a sensor array, the auxiliary function dataset, the auxiliary function dataset including an indication of a manual adjustment of an autonomous execution of the completed auxiliary function cycle.

In some aspects, the techniques described herein relate to a computer-readable, non-transitory storage medium, wherein the one or more parameters include one or more of interruption type, completion status, error state flag, re-initiation, cart alignment, obstruction presence, manual override duration, control system confidence level, or learning mode.

In some aspects, the techniques described herein relate to a computer-readable, non-transitory storage medium, the method further including: generating, by the one or more processors, a heatmap based at least in part on the auxiliary function tracker, wherein the heatmap indicates geographic regions associated with completed auxiliary function cycles, and wherein the heatmap is segmented by cycle mode and the one or more parameters of the auxiliary function dataset.

In some aspects, the techniques described herein relate to a computer-readable, non-transitory storage medium, the method further including: training, by the one or more processors, a machine learning model using the auxiliary function dataset and the updated auxiliary function tracker, wherein the machine learning model is configured to predict a cycle mode of a future auxiliary function cycle based at least in part on the one or more parameters.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a refuse vehicle, according to an exemplary embodiment; and

FIG. 2 is a block diagram of a system for determining cycle modes of an auxiliary function, according to an exemplary embodiment.

FIG. 3 is a block diagram of a system for determining cycle modes of an auxiliary function, according to an exemplary embodiment.

FIG. 4 is a flow diagram of a method for determining cycle modes of an auxiliary function, according to an exemplary embodiment.

FIG. 5 is a flow diagram of a method for determining cycle modes of an auxiliary function, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

The methods and systems described herein relate to determining and counting the number of cycles (and corresponding cycle modes) of an auxiliary function of a refuse vehicle (also referred to herein as a vehicle) such as a garbage truck, a waste collection truck, a sanitation truck, etc. For purposes of this description, a full execution of the auxiliary function from initiation through termination may constitute a single cycle. When such an execution is carried out completely, it may be considered a completed auxiliary function cycle, and data corresponding to that cycle is collected as an auxiliary function dataset of associated parameters. The vehicle may be equipped with various subsystems for executing various auxiliary functions and methods. For example, the vehicle may include an auxiliary subsystem configured to execute the auxiliary function. In some embodiments, the auxiliary subsystem may include a hydraulic system hydraulicly coupled to a lift assembly for lifting a refuse cart (referred to herein as a cart) and articulating such that the contents of the cart are disposed into an onboard hopper, collection chamber, or refuse compartment. Although various embodiments of the auxiliary function described herein involve a lift assembly for lifting carts, it should be understood that the methods and systems described herein may relate to one or more additional or alternative auxiliary subsystems. Alternative or additional auxiliary subsystems may include, but are not limited to, a compaction subsystem, a collection subsystem, a vehicle entry subsystem, and/or other similar subsystem. It should also be understood that similar systems and methods may be implemented for autonomous function usage and tracking for other types of vocational vehicles, including fire trucks, military vehicles, lift vehicles, delivery vehicles, concrete mixers, and others.

In some embodiments, the auxiliary subsystem may be coupled to a data collection system of the vehicle. Data collection systems of the vehicle may receive data related to the auxiliary subsystem during the operation of the vehicle, specifically, during the operation and execution of the auxiliary function. Data received by the data collection system may include instructions to execute the auxiliary function, an initiation location of the instructions to execute the auxiliary function, operator interface commands, operating parameters of the vehicle, and/or data from a joystick signal, a proximity switch, position sensor, hydraulic valve, an inverter, DC/DC converter or a combination thereof.

The data collection system of the vehicle may transmit the received data to one or more of a user device or a service manager. The data collection system may also transmit the data within the vehicle to an auxiliary function detection system which may be used to determine whether an auxiliary function has been executed and the surrounding conditions upon which the execution occurred. For example, the auxiliary function detection system may receive data from the data collection system and determine that the vehicle has executed an autonomous collection of a cart. This determination may be made due to the various instruction signals received by the data collection system and/or sensor data received by the data collection system.

In addition to determining whether or not an auxiliary function has been executed, the auxiliary function detection system (or the data collection system) may additionally determine the conditions under which the auxiliary function was executed. For example, the auxiliary function detection system may determine a cycle mode of the auxiliary function, the cycle mode indicating whether or not the auxiliary function was executed autonomously and/or if a manual adjustment was made. For example, the autonomous collection of the cart may be initiated from a user command, after which the autonomous collection of the cart begins. During the autonomous collection, however, the user may interrupt the autonomous collection through the use of a joystick or other user input used to adjust the position or function of the auxiliary system. The data collection system may receive an indication of such manual interruption and transmit the indication to the auxiliary function detection system. The auxiliary function detection system may receive the indication of the manual interruption and determine that the autonomous collection was interrupted by a manual adjustment by the operator. Upon making the manual adjustment, the operator may stop manually adjusting the auxiliary function and allow the autonomous collection to continue to termination. In some embodiments, the user must make an indication (such as pressing a “start auto cycle” button) to reinitiate the autonomous collection. The auxiliary function detection system may receive an indication that the operator ended manual adjustments and allowed the autonomous collection to continue to termination. Upon making this determination, the auxiliary function detection system may update an auxiliary function tracker in a database, the update corresponding to the determined cycle mode (e.g., autonomous initiation, manual adjustment, autonomous termination). In some embodiments, the cycle mode may include three cycle parameters corresponding to three phases of the collection event: (1) an initiation, (2) an adjustment, and (3) a termination. Each of the three cycle parameters may be either autonomous or manual. Each combination of cycle parameters may relate to a distinct cycle mode. This allows the auxiliary function detection system to track the number of times the auxiliary function is executed (e.g., a completed auxiliary function cycle) per cycle mode.

This tracking may be stored in a database and/or transmitted to various displays and/or servers. Additionally or alternatively, the auxiliary function detection system may generate reports for display, the reports displaying the number of cycles of execution of the auxiliary function broken down by cycle mode.

In some embodiments, the vehicle may include various modules that may be used to transmit instructions to the auxiliary subsystem to execute the auxiliary function. These various modules may include, for example, an autonomous module and/or a user interface module. In some embodiments, the auxiliary function detection system may receive an indication from which module the instruction to execute the auxiliary function originates. In so doing, the auxiliary function detection system may determine whether or not an action was autonomously executed or manually executed. By way of example, instructions to execute the auxiliary function originating from an autonomous module may be considered as being executed autonomously. Instructions originating from a user interface module may be considered as being executed manually. This distinction of origination may be done through the use of unique CAN address identifiers that are used during the CAN message broadcasts. The auxiliary function detection system may read CAN message broadcasts and parse the unique CAN addresses from the message to determine the origination of the instruction.

In some embodiments, vehicle operating parameters are received and stored by the auxiliary function detection system and correlated to each auxiliary function cycle and the corresponding cycle mode. Machine learning and/or artificial intelligence algorithms may be trained using the recorded operating parameters and environmental sensor data corresponding to various cycle mode executions. For example, cycle modes that are fully autonomously executed without manual interruption or adjustment may be used to train machine learning algorithms for autonomous operation of the vehicle.

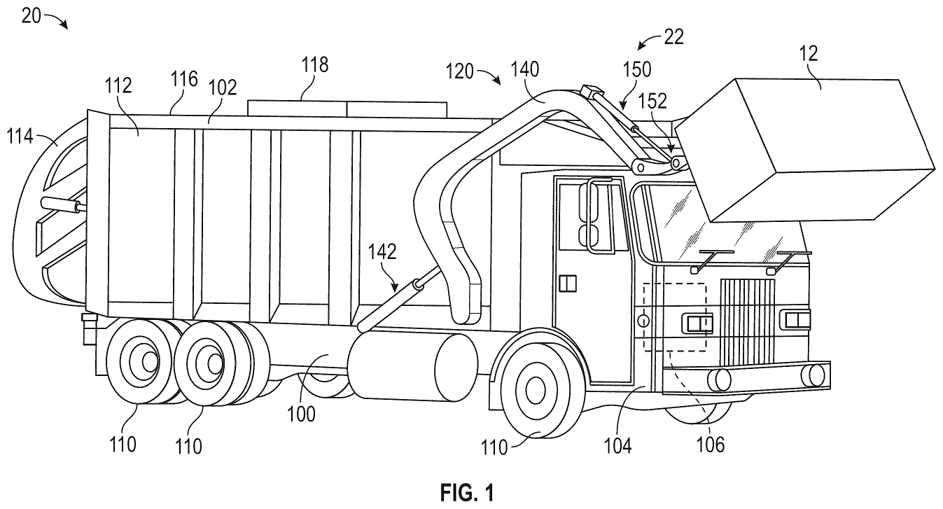

Referring now to FIG. 1, a refuse vehicle (e.g., vehicle 20) is shown according to various embodiments. The vehicle 20 may be configured as a front-loading, rear-loading, or side-loading waste collection vehicle, and may be referred to as a garbage truck, sanitation truck, or similar refuse-handling vehicle. The vehicle 20 includes a frame 100 supporting a body 102 and a cab 104. A plurality of wheels, shown as wheels 110, is rotatably coupled to the frame 100 and supports the vehicle 20 during movement. The wheels 110 may be connected by one or more axles, which in turn may be coupled to a drive system or suspension components.

The body 102 defines a refuse compartment 116 for receiving and storing waste material collected by the vehicle. A tailgate 114 is positioned at the rear of the body 102 and may be moveable between open and closed positions to allow for the discharge of refuse from the refuse compartment 116. Within the refuse compartment 116, an ejector 118 may be provided and is configured to translate rearward toward the tailgate 114 to force collected refuse out of the refuse compartment 116 during a dump cycle. In some embodiments, the refuse compartment 116 includes one or more panels 112.

The vehicle 20 includes a collector 22, which in the illustrated embodiment is configured as a front-loading lift assembly. The collector 22 includes a pair of lift arms 140 that are rotatably coupled to the frame 100 and/or the body 102 such that the lift arms 140 extend forward of the cab 104. In alternative embodiments, the collector 22 may extend rearward of the body 102 (e.g., for a rear-loading configuration) or laterally from the side of the body 102 (e.g., for a side-loading configuration). The lift arms 140 are pivotally mounted to the frame 100 via a pivot mechanism, which may include lugs, shafts, or other rotational connectors.

Each lift arm 140 is actuated by a corresponding lift arm actuator of the lift arm actuators 142. The lift arm actuators 142 are positioned between the frame 100 and the lift arms 140 and are configured such that extension and retraction of the lift arm actuators 142 rotates the lift arms 140 about the pivot axis. The collector 22 also includes fork actuators 150 configured to actuate a pair of forks 152 that are coupled to the distal ends of the lift arms 140. The forks 152 are configured to engage a refuse container 12—such as a commercial dumpster—by inserting into lift channels or fork pockets formed on the container. The fork actuators 150 enable rotation of the forks 152 relative to the lift arms 140 to facilitate the dumping of contents from the refuse container 12 into the refuse compartment 116.

In some embodiments, the vehicle 20 may include an adapter for the collector 22 that enables side-loading operation. The adapter may include an articulated mechanism, such as a grabber assembly 120, configured to grip residential roll carts or similar side-loading containers. In such embodiments, the grabber assembly 120 may transfer waste into an intermediate basket (not shown), which is subsequently dumped into the refuse compartment 116 by actuating the lift arm actuators 142. The integrated use of the collector 22, lift arms 140, lift arm actuators 142, fork actuators 150, and forks 152 allows the vehicle 20 to operate flexibly across multiple loading configurations, while components such as the frame 100, body 102, wheels 110, axles, cab 104, tailgate 114, ejector 118, and refuse compartment 116 provide structural and functional support for full-system operation.

The vehicle 20 further includes a prime mover 106 coupled to the frame 100. The prime mover 106 provides power to the wheels 110 (or other tractive members), and to other systems of the vehicle (e.g., a pneumatic system, a hydraulic system, an electric system, etc.). The vehicle 20 may include at least two axles. In some embodiments, the vehicle 20 may include at least four axles, and may include five axles in various embodiments.

The prime mover 106 may be configured to use a variety of fuels (e.g., gasoline, diesel, biodiesel, ethanol, natural gas, etc.), according to various exemplary embodiments. According to an alternative embodiment, the prime mover 106 includes one or more electric motors coupled to the frame 100. The electric motors may consume electrical power from an on-board storage device (e.g., batteries, ultra-capacitors, etc.), from an on-board generator (e.g., an internal combustion engine, high efficiency solar panels, regenerative braking system, etc.), or from an external power source (e.g., overhead power lines) and provide power to the systems of the vehicle 20. According to some embodiments, the vehicle 20 may be in other configurations than shown in FIG. 1.

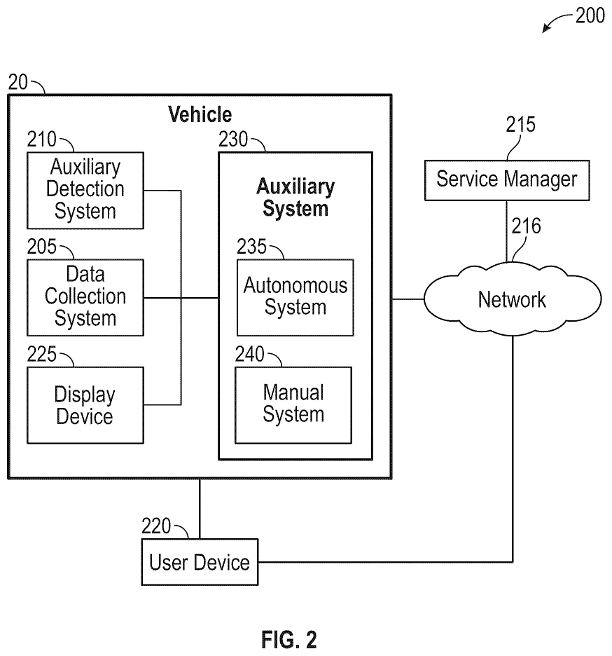

Referring now to FIG. 2, a monitoring system is shown as system 200. The system 200 includes one or more vehicles (e.g., vehicle 20), a service manager 215, and one or more user devices, shown as user device 220. The vehicle 20 includes a data collection system 205 and an auxiliary function detection system 210. The vehicle 20 can interface with the user device 220 and/or the service manager 215. The vehicle 20 can provide information to the user device 220 and/or the service manager 215. Similarly, the vehicle 20 can receive information from the user device 220 and/or the service manager 215. The information can include information associated with the number of auxiliary functions and/or other vehicle operations (e.g., emptying the collector 22, actuating the lift arms 140, and/or other vehicle or vehicle body operations shown in FIG. 1). For example, the vehicle 20 can provide to the service manager 215 a report that indicates the number of auxiliary function cycles that have occurred, and various detailed information related to each auxiliary function cycle. For example, the report may be broken down into a number of auxiliary function cycles that were entirely autonomously completed; entirely manually completed; autonomously initiated, manually interrupted, and autonomously completed; and/or autonomously initiated, manually interrupted, and manually completed. In some embodiments, the auxiliary functions may be referred to as functions of the vehicle that may be manually and/or autonomously executed. The auxiliary functions may include cart collection, refuse compaction, refuse ejection, and/or autonomous navigation.

For example, a front-loading refuse vehicle may initiate an autonomous lift sequence when a front-mounted vision system detects that a commercial dumpster is aligned within a predefined collection zone. The vision-based detection system, in conjunction with GPS coordinates, confirms that the vehicle is at a designated pickup location. Once the alignment is validated, the system autonomously deploys the lift arms 140 and forks 152 to engage the refuse container 12 without any operator input. The auxiliary function detection system receives confirmation from proximity sensors that the lift arms have reached engagement position and logs this autonomous initiation event. If the operator does not intervene, the system proceeds through the full dump cycle automatically and completes the lift, constituting a fully autonomous auxiliary function cycle.

The system 200 may include one or more networks, shown as network 216. The network 216 facilitates communication between the various components of the system 200, including the vehicle 20, the service manager 215, and user device 220. In some embodiments, the network 216 may include one or more wired or wireless communication links, such as cellular networks, Wi-Fi networks, controller area networks (CAN), Ethernet connections, satellite communication systems, or other suitable communication infrastructures. The network 216 enables the transmission of data such as auxiliary function cycle information, telematics data, operational reports, and user commands between the vehicle 20 and external systems, including remote servers or cloud-based services managed by the service manager 215. The network 216 may further support secure data transfer protocols to protect sensitive operational data and may operate over private or public communication channels, depending on the implementation. In some embodiments, the network 216 may also facilitate real-time or near-real-time updates, allowing the service manager 215 and user device 220 to receive ongoing status reports from the vehicle 20 and issue control or configuration commands as needed.

In some embodiments, the data collection system 205 can receive vehicle data from the auxiliary function detection system 210, the user device 220, and/or the service manager 215. In some embodiments, the data received can include telematics data (e.g., GPS location, vehicle speed, engine diagnostics, fuel level, hydraulic pressure, joystick position, auxiliary function status, or CAN bus messages). In some embodiments, the data collection system 205, the service manager 215, and/or the user device 220 can interface using a controller area network (CAN). The data collection system 205 can transmit the vehicle data to the auxiliary function detection system 210 to determine if an auxiliary function has occurred and under what circumstances it was completed. For example, the data collection system 205 can receive an indication of a button depression, wherein the button is associated with a command to initiate an autonomous cart collection. The data collection system 205 may receive the indication and transmit the received indication to the auxiliary function detection system 210. In addition, the data collection system 205 may receive indications of a manual operation of the auxiliary function, such as manually controlling the lift assembly and/or manually interrupting the autonomous collection.

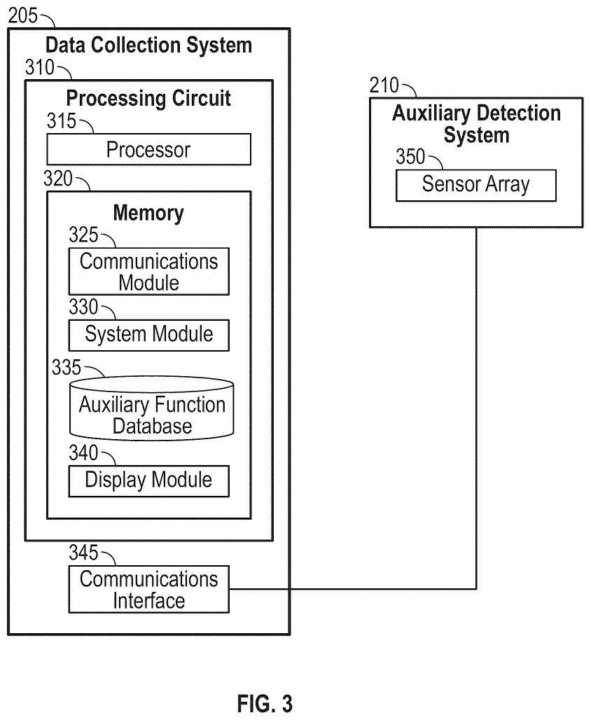

In some embodiments, the data collection system 205 and/or the auxiliary function detection system 210 can provide the received data, including the determined auxiliary function cycle, to the service manager 215 and/or the user device 220. Environmental details from various perception sensors (e.g., a sensor array of FIG. 3) may be included in the transmitted data. The environmental details may be linked to the auxiliary function indication. In some embodiments, the service manager 215 and/or the data collection system 205 can analyze a route taken by the vehicle which includes the auxiliary function cycle and the environmental or vehicle conditions that resulted in the determined cycle mode (e.g., a manual interruption of an automatic cycle of the auxiliary function).

The vehicle 20 may also include an auxiliary system 230 that is used to execute one or more auxiliary functions. The auxiliary system 230 may include an autonomous system 235 that is configured to transmit instructions (e.g., control signals) to the auxiliary system 230 to operate the auxiliary system 230 autonomously. The instructions may, in some embodiments, be related to executing the auxiliary function. For example, the autonomous system 235 may detect that the vehicle is positioned near a curbside residential cart based on GPS location and alignment data from a LIDAR system. In response, the autonomous system 235 transmits control signals to the auxiliary system 230 to extend a side-mounted lift arm, actuate the grabber assembly 120, and raise the cart for dumping. During this process, no manual inputs are detected, and the system continues through the complete lift and lower cycle using only autonomous instructions. This operation is logged by the auxiliary function detection system as a fully autonomous cycle, with initiation, adjustment, and termination all executed by the autonomous system 235.

Likewise, the manual system 240 may transmit instructions (e.g., control signals) to the auxiliary system 230 to execute the auxiliary function, the instructions from the manual system 240 being generated based at least in part on manual input from a human-machine interface device of the vehicle 20. The data collection system 205 may receive an indication of when instructions are sent from the autonomous system 235 and/or the manual system 240 and use this indication in determining whether auxiliary functions are executed autonomously or manually.

In another example, a side-loading refuse vehicle may begin an autonomous lift cycle to collect a residential cart, but midway through the process, the cart becomes partially jammed or misaligned. The operator observes this condition and manually adjusts the joystick to reposition the grabber assembly. The system recognizes the joystick deflection as a manual adjustment, classifies the event accordingly, and pauses the autonomous control. The operator then completes the lift manually. The auxiliary function detection system records this cycle as one with an autonomous initiation, manual adjustment, and manual termination. This cycle classification is stored in the auxiliary function tracker and can be used to evaluate recurring intervention patterns across similar locations or operators. In some embodiments, the information including the auxiliary function cycle can be used for training drivers (e.g., autonomous driving systems) of a vehicle. For example, a driver or autonomous driving system can be trained to avoid situations that result in manual interruption of an autonomous auxiliary function. Likewise, the information may be used to train a machine learning model and/or an artificial intelligence model for autonomous driving.

For instance, if an operator consistently interrupts the autonomous function when the vehicle is positioned on narrow streets, the system can log these occurrences and correlate them with environmental conditions (e.g., GPS, terrain, surrounding obstacles). These records may be used to train the autonomous system to adaptively reduce lift arm speed or initiate a pre-alignment adjustment protocol before attempting engagement in similar environments. Likewise, if a particular operator completes a high number of uninterrupted autonomous cycles, that behavioral data can be fed into a supervised learning framework to model best practices for autonomous alignment and engagement strategies. The system thus evolves using actual field data as a reinforcement basis for predictive decision-making.

Referring now to FIG. 3, an exemplary embodiment of the data collection system 205 is illustrated. As shown, the data collection system 205 includes a processing circuit 310 and a communications interface 345. The processing circuit 310 may include one or more processors 315 and a memory 320. The memory 320 may be configured to store instructions for executing various software modules, including a communications module 325, a system module 330, an auxiliary function database 335, and a display module 340. Each of these modules may perform distinct operations associated with data acquisition, auxiliary function monitoring, reporting, and interfacing with external devices or systems. The auxiliary function detection system 210, which may be co-located with or separate from the data collection system 205, includes a sensor array 350 configured to collect telemetry and operational data related to the auxiliary functions of the vehicle. The sensor array 350 may include any number of sensors as described herein and may provide data to the data collection system 205 via the communications interface 345. Although certain components in FIG. 3 share reference numerals with those depicted in FIG. 2, it should be understood that these components may represent similar or different implementations, configurations, or subcomponents depending on the embodiment.

The one or more processors 315 may be a general purpose or specific purpose processor, an application specific integrated circuit (ASIC), one or more field programmable gate arrays (FPGAs), a group of processing components, or other suitable processing components. The one or more processors 315 may be configured to execute computer code or instructions stored in memory 320 or received from other computer readable media (e.g., CD-ROM, network storage, a remote server, etc.) to perform one or more of the processes described herein. Memory 320 may include one or more data storage devices (e.g., memory units, memory devices, computer-readable storage media, etc.) configured to store data, computer code, executable instructions, or other forms of computer-readable information. Memory 320 may include random access memory (RAM), read-only memory (ROM), hard drive storage, temporary storage, non-volatile memory, flash memory, optical memory, or any other suitable memory for storing software objects and/or computer instructions. Memory 320 may include database components, object code components, script components, or any other type of information structure for supporting the various activities and information structures described in the present disclosure. Memory 320 may be communicably connected to one or more processors 315 via processing circuit 310 and may include computer code for executing (e.g., by one or more processors 315) one or more of the processes described herein.

The memory 320 is described below as including various modules. While the exemplary embodiment shown in the figures shows each of communications module 325, system module 330, and/or the display module 340 as being separate from one another, it should be understood that, in various other embodiments, the memory may include more, less, or altogether different modules. For example, the structures and functions of one module may be performed by another module, or the activities of two modules may be combined such that they are performed by only a single module.

The communications module 325 is configured to facilitate communications (e.g., wireless or wired) with external computing systems and with other vehicles via communications interface 345 (e.g., a transceiver, etc.). Communications interface 345 may support any kind of wireless standard (e.g., 802.11 b/g/n, 802.11a, etc.) and may interface with any type of external computing system wireless communication capability (e.g., cellular, Wi-Fi, etc.). Communications interface 345 may further facilitate wireless communications with an external global positioning system (GPS). Communications module 325 may be any type of capable module (e.g., a CL-T04 CANect® Wi-Fi Module manufactured by HED Inc., etc.) configured to support wireless communications with the external computing systems and other response vehicles. In one embodiment, the external computing systems communicate with the response vehicles via Wi-Fi. In other embodiments, the communications between the external computing systems and/or response vehicles may be supported via CDMA, GSM, or another cellular connection. In still other embodiments, another wireless protocol is utilized (e.g., Bluetooth, Zigbee, radio, etc.).

The system module 330 is structured to enable the one or more processors 315 of the data collection system 205 to interface with the auxiliary function detection system 210 of the vehicle 20. In the exemplary embodiment shown, the data collection system 205, via the system module 330, may generate a vehicle system report based on various sensor data points received from the auxiliary function detection system 210. The report may be generated by comparing the sensor data points received from the auxiliary function detection system 210. For example, a baseline sensor value for the auxiliary function detection system 210 may include an initial location of a component of the auxiliary system (e.g., the lift assembly) or a user input system (e.g., a human-machine interface system, such as a joystick). Thus, upon receipt of a sensor data point indicative of the location of the joystick interface, the one or more processors 315 may compare the received data point to the baseline value to determine if a manual interruption of the auxiliary function (e.g., an autonomous collection) has occurred. For instance, during an autonomous side-load cart collection, the system may detect that the lift assembly began its movement sequence based on a command originating from an autonomous module. If, during the lift sequence, a joystick displacement exceeds a predefined threshold, the system may classify the operation as having experienced a manual interruption. Likewise, upon receipt of a sensor data point indicative of the location of a lift device—such as confirmation that the lift assembly has reached the dump position—the one or more processors 315 may determine that a lift sequence was successfully completed. The generated report may indicate a total number of executed (or unexecuted) auxiliary function cycles per cycle mode (e.g., autonomous, manual, autonomous with manual interruption, or autonomous with manual termination). As will be understood, there may be multiple baseline values with respect to each sensor of the auxiliary function detection system 210.

To determine and count auxiliary function cycles, the system module 330 evaluates telemetry and control signal data corresponding to key events associated with the operation of the auxiliary system. For each event, the system records three temporal indicators: the initiation, adjustment, and termination of the auxiliary function. Each indicator is classified based on the origin of the control input, such as whether the signal was issued by the autonomous system 235 or the manual system 240. For example, if a lift sequence is initiated by a user pressing an “Auto Collect” button mapped to an autonomous system command, and the sequence completes without any additional manual commands, the cycle is counted as an autonomous cycle. If, however, the same sequence is manually overridden mid-way through by a joystick movement, the adjustment phase is tagged as manual, and the cycle is classified accordingly (e.g., “autonomous with manual interruption”). The system module 330 aggregates these classifications in real time, incrementing counters for each respective cycle mode and storing them in the auxiliary function database 335. This counting logic allows for fine-grained breakdowns of operational behavior across a fleet of vehicles and can inform operator training, vehicle diagnostics, and algorithm refinement.

According to various embodiments, the system module 330 is structured to enable the one or more processors 315 to modify the sample rate of the various sensors included in auxiliary function detection system 210. For example, the one or more processors 315 may modify the sample rate of a particular sensor in response to detecting a particular operating state. In this sense, the one or more processors 315 may cause each sensor to selectively record data points at predetermined intervals. For example, the one or more processors 315 may determine an operating state of the vehicle (e.g., a collection state, a compaction state, an emergency response, pumping event, etc.) and adjust the predetermined intervals accordingly. For example, the one or more processors 315 may cause the sample rate of the sensors to change depending on the operating state of the vehicle. According to various embodiments, the first rate corresponds with the sensors taking measurements at a more frequent rate (e.g., once every two minutes) than the second rate (e.g., once every thirty minutes).

By way of example, during a cart collection event, the one or more processors 315 may detect that the lift assembly has begun movement toward a refuse cart based on sensor feedback from proximity switches and actuator position sensors. Upon detecting this collection state, the one or more processors 315 may automatically increase the sampling frequency of the joystick position sensor and the hydraulic pressure sensors from once every thirty minutes to once every two seconds. This higher resolution sampling allows for precise tracking of any manual overrides, interruptions, or anomalies during the lift sequence. Once the collection event is completed and the auxiliary system returns to a standby or transit state, the one or more processors 315 may revert the sample rate of the sensors back to the lower frequency to conserve processing resources, reduce data storage load, and minimize network bandwidth usage. This dynamic adjustment ensures that operational data is captured with high fidelity during events, without unnecessarily burdening the system during routine driving or idle periods.

The system module 330 may be structured to interface with various other modules to present the vehicle system report to an operator and/or other user. For example, the system module 330 may interface with the display module 340 to present the operator with the vehicle system report via the display device 225. The display module 340 may be configured to present the generated vehicle systems report on the display device 225 (e.g., via an interactive graphical user interface). Alternatively or additionally, the system module 330 may interface with the communications module 325 so as to format the generated vehicle system report into a webpage or the like that is viewable on a display device (e.g., user device 220) included in an external computing system and transmit the report data to the external computing system via a secure connection. The communications module 325 may facilitate the transmission of the generated report to a telematics portal (whether remote or local) and/or a telematics control unit. The telematics portal and/or the display module 340 may display the received report including the count of a number of executed cycles of the auxiliary function and, in some embodiments, the breakdown of the number of cycles per cycle mode of the auxiliary function. In other words, instructions can be transmitted to a user's electronic device to present the updated auxiliary function tracker on its display, allowing an operator or fleet manager to view the latest cycle counts and modes for the auxiliary function.

The auxiliary function database 335 may include, for example, telemetric data captured by the auxiliary function detection system 210. The auxiliary function database 335 may be located in one or more modules within the data collection system 205. For example, the auxiliary function database 335 may be located in a body control module (not shown) or an autonomy control module, and/or a separate module communicably coupled to the body control module. For example, the system module 330 may include a data logger or the like that stores any sensor data points received from the auxiliary function detection system 210. The auxiliary function database 335 may include a plurality of telemetry datasets, with each dataset corresponding to a different sensor device of the auxiliary function detection system 210. Each dataset may include a plurality of entries, with each entry including a sensor data point value and a time stamp. Alternatively or additionally, the auxiliary function database 335 may store the vehicle system reports generated via the system module 330.

The stored data may be removed from the auxiliary function database 335 once the data is uploaded to a remote cloud storage. For example, long-term storage of the telemetry data and other data may be done on a centralized server, and communications interface 345 may wirelessly connect with a remote server to transmit and store the data. The data includes a timestamp and vehicle identifier information to identify the data in a remote server. In some embodiments, the service manager 215 can perform similar functionality to a remote server.

In one embodiment, the data is automatically updated periodically. The data may also be updated upon user request. A controller area network (CAN) controller, such as system module 330 or another module, may be configured to monitor the data and to determine when a potential status of the vehicle 20 has changed based on the telemetry data changes (e.g., that an autonomous auxiliary function has cycled, a manual adjustment was made, etc.).

According to various embodiments, the processor may selectively transmit a subset of the data (e.g., data points from a specific subset of sensors) in response to an operating state of the vehicle being determined. For example, the data collection system may transmit data points from certain sensors (e.g., a joystick position sensor) at a higher rate during cart collection than other sensors (e.g., an engine output sensor). By reducing the total number of data points being transmitted, the strain on the communications interface 345 may be reduced.

Auxiliary function database 335 may be any type of database (e.g., a SQLite database, etc.), and the modules (e.g., the communications module 325, the system module 330, and/or the 340//) may query the database using any type of language or method via backend framework. The backend framework of data collection system 205 may support the activities of periodically updating and querying auxiliary function database 335, as well as providing web layer authentication (e.g., to authenticate devices that attempt to access data from auxiliary function database 335, etc.). The backend framework may further support the various security-related functionality of communications module 325.

The data collection system 205 may include, for example, a data transport protocol layer configured to facilitate the query of data from auxiliary function database 335 for use by the various modules of memory 320. In one embodiment, at least one of WebSocket and AJAX polling is used to invoke queries via a backend framework and provide the data to the frontend applications (e.g., the application layer, the modules, etc.), as they allow changes to the auxiliary function database 335 to be detected and pushed to the application layer. The use of web sockets and/or AJAX may be based on compatibility constraints and performance constraints with the external computing system accessing the data collection system 205. The application layer, or the frontend application, of data collection system 205 may be built using, for example, HTML5, CSS, and various JavaScript libraries.

The sensor array 350 can include one or more sensors. The sensors can be at least one of a position sensor, a proximity sensor, a joystick position sensor, a joystick button sensor, a location sensor, a fuel sensor, an engine sensor, a drive mode sensor, a pump sensor, a collector sensor, a CAN sensor, and/or a temperature sensor. In at least one embodiment, the joystick position sensor may receive position data of a joystick (the joystick being part of the communications interface 345). The sensor array 350 can provide the position data of the auxiliary device (e.g., the lift assembly) to the communications interface 345. The system module 330 can use the position data to determine if an auxiliary function has cycled and whether any manual interruptions occurred during the cycle. In some embodiments, the system module 330 may use the number of auxiliary function cycles to determine an operator score. For example, the operator score may decrease with every manual adjustment that needs to be made during an autonomous auxiliary function cycle. Thus, the system module uses the number of auxiliary function cycles in addition to the number and result of any manual adjustments to determine the operator score. The operator score may be used for training to aid operators in positioning an operated vehicle in appropriate positions prior to performing autonomous functions, thus increasing the use of fully autonomous functions. Data collected by the auxiliary function detection system 210 may then be used to train various autonomous driving, machine-learning algorithms based on the operator's operation of the vehicle to maximize autonomous auxiliary functions.

In some embodiments, the sensor array 350 may include one or more proximity sensors that measure a position of a device associated with the auxiliary system. For example, a proximity sensor may be used to measure whether a lift assembly completed a cycle by measuring whether or not the lift assembly reached an end position (e.g., a dump position) or other checkpoint position during an auxiliary function cycle. The proximity sensor may be a reed switch, a limit switch, an inductive sensor, a capacitive sensor, an ultrasonic sensor, a photoelectric sensor, a magnetic sensor, a laser sensor, a Hall effect sensor, a radar sensor, and/or an infrared sensor.

In some embodiments, the service manager 215 can perform similar functionality to the data collection system 205 and/or the auxiliary function detection system 210. For example, the data collected by the auxiliary function detection system 210 can be provided to the service manager 215. The service manager 215 can use the data to determine whether an auxiliary function has cycled (whether automatic or manual) and any manual adjustments that were made during the cycle. The service manager 215 may also determine whether the cycle was autonomously or manually initiated, adjusted, and/or completed.

In some embodiments, the data collection system 205 and/or the auxiliary function detection system 210 can perform similar functionality to a telematics control unit (TCU) connected to a Controller Area Network bus which can interface with a remote data center. In some embodiments, the data collected by the data collection system 205 and/or the auxiliary function detection system 210 can be provided to the service manager 215 (e.g., remote data center) or the system module 330. The service manager 215 can analyze the data provided by the data collection system 205 and/or the vehicle detection system. For example, the data provided to the service manager 215 can control signals sent to various auxiliary subsystems that execute the auxiliary functions. The data may include destination systems for the instructions and from which system the instructions were transmitted from, such as initiation systems (e.g., from the communications interface 345, the autonomous function subsystem, or the manual subsystem).

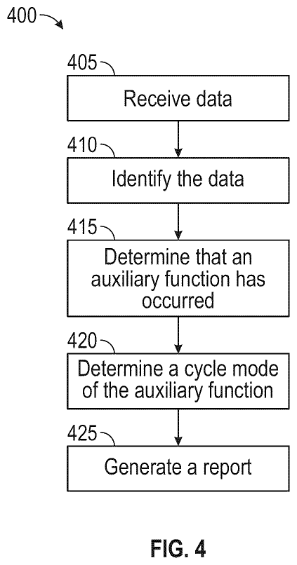

Referring now to FIG. 4, a process 400 is shown. In some embodiments, the data collection system 205, the auxiliary function detection system 210, and/or the service manager 215 can perform the process 400 to monitor, classify, and record auxiliary function cycles based on telemetry and control data. The process 400 provides a structured approach for determining not only whether an auxiliary function occurred, but also under what conditions it was initiated, modified, or completed.

The process 400 shown in FIG. 4 operates to detect and classify each completed auxiliary function cycle, including associating the cycle with one or more parameters derived from sensor and control input data. The cycle mode corresponding to the completed auxiliary function cycle is determined by evaluating these parameters. Each auxiliary function dataset includes information identifying whether the function was autonomously initiated, whether a manual adjustment occurred, and whether the cycle was autonomously or manually terminated. These parameters are stored and used to update an auxiliary function tracker, which maintains an aggregated count and classification of completed auxiliary function cycles. The auxiliary function dataset may be transmitted from a sensor array and may include a manual adjustment indication during the autonomous execution of a completed auxiliary function cycle. The cycle mode may be selected from among an autonomous cycle, an autonomous cycle with manual interruption, an autonomous cycle with manual completion, and a manual cycle.

At step 405, data is received. The incoming signals and sensor readings form an auxiliary function dataset that includes parameters corresponding to the completed auxiliary function cycle. The auxiliary function dataset may be constructed in real-time or from previously stored vehicle telemetry, and may be formatted for evaluation by the auxiliary function detection system 210. The parameters may include values relevant to execution status, timing, source of control signal, and system state transitions. In some embodiments, the auxiliary function dataset includes control instructions, actuator movements, joystick inputs, or positional readings associated with a given completed auxiliary function cycle. These signals allow the system to determine not only that an auxiliary function cycle has occurred, but also the specific cycle mode in which it was executed. The data received can originate from the sensor array 350, which may include various physical sensors such as joystick position sensors, proximity switches, hydraulic pressure sensors, or actuator encoders. Additionally, the data may be collected from the vehicle's Controller Area Network (CAN) bus, which carries messages from multiple systems including the autonomous system 235 and the manual system 240. The incoming data may include operator input signals, such as the actuation of an “auto collect” button or the manipulation of a joystick, as well as environmental and operational parameters like lift arm position, cycle timing, or force feedback. Transmission metadata may also be captured, including a message's origination address (e.g., identifying whether it came from the autonomous or manual system) and its intended destination, allowing the system to determine the context and purpose of the transmitted instruction. These data points form a structured record within the auxiliary function dataset, which supports downstream analysis to determine the cycle mode of the completed auxiliary function cycle.

For example, the system may receive data from a proximity sensor indicating that a refuse cart is within the predefined pick-up zone of the vehicle. Simultaneously, a CAN message may be received with an identifier corresponding to the autonomous module, indicating that the lift assembly should begin an automatic cart collection. The sensor array may also report the initial position of the lift arms and record timestamped data as the lift operation begins. These data entries are stored as part of the auxiliary function dataset and represent key parameters for determining the operational context of the completed auxiliary function cycle. Once collected, this auxiliary function dataset is used to infer whether the event aligns with a fully autonomous operation, a manually initiated cycle, or a cycle mode involving mixed control inputs. The structured nature of the dataset facilitates precise classification of the completed auxiliary function cycle based on detected system behavior and operator interaction.

At step 410, the received data is identified and classified. The system module 330 parses the incoming data to determine its relevance to the auxiliary function monitoring process. In particular, the system module evaluates entries in the auxiliary function dataset to extract and classify specific parameters that characterize an operational event as a completed auxiliary function cycle. These parameters may include, for example, signal source, actuator state, timing, or sensor threshold crossings. The classification process enables the system to determine a cycle mode for each completed auxiliary function cycle, including whether it was autonomously initiated, manually adjusted, or fully executed without operator intervention. For example, the system module may identify joystick deflection data as indicative of a manual override or determine that a button press signal correlates with an instruction to initiate an autonomous cycle. The classification process involves correlating the message content with known instruction types and associating signals with specific phases of an auxiliary function event—such as initiation, adjustment, or termination. Each event is logged in the auxiliary function tracker using a structured format derived from the auxiliary function dataset, enabling traceable and consistent representation of the cycle mode.

For instance, if a joystick movement is detected during an ongoing autonomous lift cycle—evidenced by a joystick deflection beyond a calibrated threshold—the system may classify this event as a manual adjustment or interruption. In this case, the parameters captured in the auxiliary function dataset identify the transition in control from autonomous to manual, and this detail is reflected in the determination of the cycle mode. The resulting completed auxiliary function cycle is then registered in the auxiliary function tracker with the corresponding cycle mode of autonomous initiation and manual adjustment. Alternatively, if a user presses a “start auto cycle” button on the operator console, and the command originates from the autonomous system 235, the system recognizes this as an autonomous initiation. If no manual inputs are subsequently detected and the lift completes as planned, the parameters recorded in the auxiliary function dataset will reflect a fully autonomous sequence. The cycle mode is classified accordingly and the completed auxiliary function cycle is stored in the auxiliary function tracker with identifiers representing a fully autonomous execution.

In some embodiments, the data identified at this step is collectively tagged as auxiliary data and passed to subsequent logic to determine whether an auxiliary function was completed, what its mode was, and whether the cycle should be recorded in the auxiliary function tracker. This identification and classification step enables the system to build a structured view of what auxiliary function activity occurred, who or what initiated it, and whether any deviations from a fully autonomous process were observed.

At step 415, the received data (whether auxiliary data or otherwise) may be used to determine if an auxiliary function has occurred. In this step, the system module 330 analyzes the classified data—organized as an auxiliary function dataset—to assess whether a completed auxiliary function cycle, or a significant portion thereof, has been executed. The analysis leverages parameters extracted from sensor inputs, telemetry records, and control signals received from the sensor array 350 and/or the vehicle's CAN system to identify events that satisfy the operational criteria for classification as a completed auxiliary function cycle.

For example, the system module 330 may monitor position data from a lift assembly actuator or proximity sensors positioned along the lift assembly path. Upon detecting that the lift assembly has reached a defined end position—such as a maximum extension or a designated dumping pose—the system may conclude, based on predefined parameters within the auxiliary function dataset, that a collection event has been completed. In one embodiment, the system may monitor a lift arm proximity sensor that detects when the arm has rotated beyond a specific angular threshold, indicating that the refuse cart has been tipped to unload its contents into the hopper. Receipt of such a signal within an expected time frame following an initiation command may trigger the determination that the auxiliary function successfully occurred and qualifies as a completed auxiliary function cycle.

In another example, the system module 330 may determine that an auxiliary function has occurred based on hydraulic pressure data. During the execution of a lift sequence, the system may monitor pressure transducers associated with hydraulic cylinders. A characteristic pressure spike followed by a pressure drop may indicate that the lift arm has engaged with a cart, lifted the load, and dumped it, thereby satisfying the operational parameters of a completed auxiliary function cycle and triggering a corresponding entry in the auxiliary function tracker.

Additionally, joystick data may be used to confirm manual completions of auxiliary functions. For instance, if an operator manually actuates the joystick to complete a lift and the sensor array reports that the lift assembly subsequently reaches the end position, the system can infer from the associated parameters in the auxiliary function dataset that although the cycle was manually assisted or completed, a completed auxiliary function cycle still occurred. The system may update the auxiliary function tracker accordingly, associating the event with a cycle mode determined by whether the cycle was autonomously or manually initiated, adjusted, or terminated.

The system module 330 may also consider temporal factors within the auxiliary function dataset to validate the occurrence of a completed auxiliary function cycle. For instance, a sequence of control inputs and corresponding sensor feedback occurring within a predefined time window may be required to recognize an auxiliary function event, thereby filtering out isolated or accidental sensor triggers that do not result in a valid cycle.

By cross-referencing multiple data points—including physical positions, control commands, timing sequences, and sensor readings—the system determines whether the auxiliary function, such as an autonomous or manual collection event, constitutes a completed auxiliary function cycle and logs it with its corresponding cycle mode in the auxiliary function tracker.

At step 420, the system module 330 determines the cycle mode of the completed auxiliary function cycle (or, in some cases, uncompleted) based at least in part on the auxiliary function dataset. This determination is made by analyzing the data received at step 405, including parameters indicating which system—either the autonomous system 235 or the manual system 240—originated the instructions associated with the auxiliary function event. The cycle mode may, in some embodiments, be defined across three discrete parameters: initiation, adjustment, and termination. Each of these parameters is evaluated independently to accurately capture the overall nature of the completed auxiliary function cycle, and these parameters are stored in association with the auxiliary function dataset for that cycle.

In embodiments in which the initiation instruction originated from the autonomous system 235, the auxiliary function is determined to have been initiated as an autonomous cycle. This may occur even when the initial instruction is triggered by a manual user action, such as pressing a “start auto-collect” button located on the vehicle operator interface. For example, an operator may press an “Auto Cart Collection” button on a touchscreen, which sends a command originating from the autonomous system 235 to begin the automatic lift sequence of the cart. Although the operator initiates the event, because the control instruction is routed through and managed by the autonomous system, the initiation is classified as autonomous and logged in the auxiliary function dataset.

Conversely, if the initiation instruction comes from the manual system 240—such as direct movement of a joystick to begin lifting a cart—the auxiliary function is determined to have a manual initiation. For instance, if an operator pushes the joystick forward to engage the lift arms without first selecting any autonomous mode, the system classifies the event as having a manual initiation and records that information as one of the parameters in the auxiliary function dataset.

Following initiation, the auxiliary function may continue either autonomously or with manual adjustment during its execution phase. The system module 330 monitors for any indications of manual adjustment during the cycle. If no manual intervention is detected after initiation—meaning subsequent control signals originate solely from the autonomous system 235—the adjustment phase is classified as autonomous. For example, if after the autonomous initiation of a cart lift, the system detects no joystick inputs or manual control signals throughout the lift, dump, and return phases, the adjustment parameter remains autonomous and is reflected as such in the auxiliary function dataset.

However, if a manual interruption or adjustment is detected during the lift sequence, such as an operator nudging the joystick to re-center a cart on the forks mid-lift, the adjustment is classified as manual. The system module 330 detects the manual intervention by recognizing that control commands originated from the manual system 240 during the execution phase. For example, a joystick movement past a threshold input range during an otherwise autonomous lift would constitute a manual adjustment and result in a corresponding update to the parameters in the auxiliary function dataset.

The termination of the auxiliary function—completing the cycle—is similarly evaluated to determine whether it was finalized autonomously or manually. If the auxiliary device (e.g., lift assembly) completes its cycle, returning to the base position or another designated endpoint without any further manual input, the termination is classified as autonomous. For example, if the lift arms automatically return to the load position after dumping without operator input, the system concludes the termination was autonomous and logs this as a parameter of the completed auxiliary function cycle.

In contrast, if the final phase of the auxiliary function is manually completed—such as the operator manually retracting the lift arms using the joystick—the termination is classified as manual. The system module 330 identifies this based on the origination of the final commands from the manual system 240 rather than the autonomous system 235. These classifications are all appended to the auxiliary function dataset and used to update the auxiliary function tracker based on the determined cycle mode of the completed auxiliary function cycle.

By analyzing initiation, adjustment, and termination independently, the system can accurately classify the complete auxiliary function cycle into one of several predefined cycle modes. These may include, but are not limited to, a fully autonomous cycle (autonomous initiation, autonomous adjustment, autonomous termination), a fully manual cycle (manual initiation, manual adjustment, manual termination), an autonomous cycle with manual interruption (autonomous initiation, manual adjustment, autonomous or manual termination), or an autonomous cycle with manual completion (autonomous initiation, autonomous adjustment, manual termination).

By way of example, an operator may initiate an autonomous cart pick-up by pressing an auto-collect button, then manually adjusts the forks mid-lift to better secure the cart, but allows the system to autonomously finish the dumping and lowering sequence. In this case, the system would classify the event as “autonomous initiation,” “manual adjustment,” and “autonomous termination,” resulting in a cycle mode of “autonomous cycle with manual interruption,” which is stored in the auxiliary function tracker as a completed auxiliary function cycle.

Thus, the system's multi-parameter approach facilitates detailed tracking of operational patterns, providing a high-resolution view of how auxiliary systems are utilized across different operating scenarios. This detailed classification enhances reporting accuracy and supports data-driven decisions for operator training, system improvements, and predictive maintenance programs. Though three parameters are described for determining the cycle mode, it is understood that more, less, or different parameters may be used in determining the cycle mode of the auxiliary function. In some embodiments, the system may incorporate additional or refined parameters within the auxiliary function dataset to provide greater diagnostic precision and operational insight. These extended parameters enable the system to categorize auxiliary function cycles with greater specificity and support advanced analytics, training feedback, and autonomous system tuning.

One such parameter is an interruption type, which may distinguish between reactive manual interventions—such as when an operator manually adjusts the lift in response to a misaligned cart or an obstacle—and proactive overrides, where the operator takes manual control without a system-detected anomaly. The system may also evaluate the completion status of the auxiliary function cycle, identifying whether the cycle completed as intended, was only partially completed, or was aborted before reaching its terminal state. This distinction may help identify trends in operational failures or user-initiated cancellations.

Another parameter may include an error state flag, indicating whether any faults or exceptions occurred during the cycle, such as a sensor failure, CAN bus timeout, or hydraulic stall. In conjunction with this, the system may track whether a manual re-initiation was required following a manual interruption. For instance, if an operator stops an autonomous lift mid-cycle, the system may record whether the cycle resumed automatically or required the operator to manually press a “resume auto cycle” button.

Environmental and situational context may also be encoded through parameters such as cart alignment, obstruction presence, or other inputs derived from proximity, vision, or radar sensors. These environmental markers help correlate manual adjustments with specific field conditions. Similarly, the duration of manual override may be recorded, allowing cycles to be classified based on the extent of operator intervention—such as brief nudges versus prolonged joystick control throughout the cycle duration.

For systems that incorporate AI or machine-learning algorithms, a control system confidence level may also be included, reflecting the autonomous controller's internal assessment of its ability to successfully complete a task without intervention. This parameter may be useful in identifying areas where autonomous confidence is low and further training data may be beneficial. Additionally, the system may flag safety events, such as when a safety interlock or emergency stop was triggered during the cycle, providing a signal for maintenance or post-cycle review.

The system may include a learning mode indicator that designates whether the cycle was performed during normal operation or under special conditions intended for training, testing, or anomaly capture. This parameter may be used to separate production data from exploratory or experimental data streams, ensuring accurate interpretation and avoiding bias in long-term analytics.

To further enrich the system's classification and analysis, a manual override duration parameter may capture the length of time manual controls were active during what would otherwise be an autonomous cycle. A control system confidence level may represent an internally computed score or flag that indicates the autonomous system's predicted success rate or readiness to complete the auxiliary function without assistance. Additionally, a learning mode parameter may distinguish between cycles executed during standard operation and those performed under experimental, diagnostic, or supervised learning scenarios, allowing for proper segmentation of production versus training data.

At step 425, a report is generated based on the analysis and classification performed in the previous steps. The report reflects a comprehensive summary of auxiliary function cycles, including their respective cycle modes and relevant contextual data. The cycle mode information is tracked and stored in a database, such as the auxiliary function database 335, or another suitable electronic storage location, which may be either onboard the vehicle or remotely hosted. This storage allows for persistent logging and historical analysis of vehicle performance over time.

For example, the system module 330 may generate a report indicating that, over the course of a single route, a total of 86 auxiliary function cycles were executed, with 60 categorized as fully autonomous, 12 classified as autonomous with manual interruption, 8 as autonomous with manual termination, and 6 as fully manual. Each category may be further broken down by timestamps, operator ID, GPS coordinates, and environmental conditions. These tallied results provide the system with high-level summaries as well as detailed breakdowns for auditing, training, or system refinement purposes. In some embodiments, the report may also incorporate geospatial correlation. By associating each auxiliary function cycle with location data obtained from a GPS receiver or another positioning system, the report may identify specific collection zones or environmental conditions where manual overrides frequently occur. For instance, if the data shows that autonomous cycles initiated on steep inclines or near tight alleyways result in manual adjustments more than 75% of the time, the system can flag these zones as “operator assist preferred” or “autonomy confidence low.” Such information may guide route planning, vehicle configuration, or targeted improvements in autonomous control algorithms.

The generated report may be displayed locally within the vehicle 20 using an onboard operator interface or transmitted to a remote interface via the communications module 325. For example, the system may push the report to a user device 220, such as a tablet or mobile phone, associated with a route supervisor or fleet technician. The communications module 325 enables secure transfer of the report data and ensures compatibility with various user-facing platforms. The report may be rendered via a user interface that presents interactive dashboards, heat maps of manual intervention zones, or tabular breakdowns of cycle mode usage by vehicle, route, or operator.

In one embodiment, the system module 330 may utilize data from the auxiliary function tracker to generate a heatmap that visually represents the spatial distribution and frequency of auxiliary function cycle modes across a service route or geographic regions. The auxiliary function tracker may include timestamped records of each executed auxiliary function cycle, along with associated metadata such as vehicle location, cycle mode classification (e.g., autonomous, manual, interrupted), and environmental context. By aggregating this data over time, the system may compute density metrics that reflect how often certain types of auxiliary function cycles occur within defined geographic regions and/or zones. In doing so, the system generates, by the one or more processors, a heatmap based at least in part on the auxiliary function tracker, wherein the heatmap indicates cycle mode frequency by region and identifies locations of anomalous or operator-assisted activity.

For example, if a refuse vehicle travels a recurring municipal route and executes a cart collection every 50 feet, the auxiliary function tracker may log whether each event was fully autonomous or required manual adjustment. When this data is correlated with GPS coordinates, the system can generate a heatmap in which color gradients correspond to the prevalence of specific cycle modes. Areas where fully autonomous cycles dominate may be rendered in green, while zones with frequent manual interruptions may appear in red or orange, indicating regions of reduced autonomous reliability. The heatmap may thus serve as a spatial diagnostic overlay derived directly from the auxiliary function tracker, allowing fleet managers or autonomous control engineers to identify patterns of operator intervention and regions where autonomous performance degrades.

In some embodiments, the heatmap generated from the auxiliary function tracker may be segmented by time of day, operator ID, vehicle configuration, or other auxiliary function dataset parameters. These segments may reflect variation in cycle mode behavior across different contexts or environmental conditions. For instance, if a particular intersection consistently requires manual override regardless of driver or vehicle, the system may flag that region as a structural concern-such as poor cart alignment, limited visibility, or challenging terrain. The auxiliary function tracker may also record parameters such as road slope, pedestrian proximity, cart misalignment, obstruction presence, or hydraulic error flags. This parameter-rich dataset supports heatmap resolution enhancement and enables the system to generate targeted overlays that not only reflect historical usage patterns but also support predictive assessment of where future interventions are likely to occur.

In some embodiments, the heatmap may include overlays that distinguish among multiple auxiliary function types (e.g., cart lift, compaction, ejection), each with a corresponding color or visual layer. The system may generate per-function heatmaps or aggregate them into a unified view. Additionally, the heatmap may visualize data corresponding to other tracked parameters, such as interruption type, manual override duration, or error state flags, as these may serve as leading indicators of automation difficulty in particular regions. The system may also apply statistical smoothing or confidence indicators derived from the control system confidence level of each recorded auxiliary function cycle.

The system may display the heatmap on a graphical user interface accessible via the user device 220 or within a centralized fleet management portal. Users may filter the heatmap by auxiliary function type, cycle mode, operator, time interval, or any logged parameter within the auxiliary function dataset. For example, a fleet supervisor may choose to view only those locations where more than 30% of auxiliary function cycles were manually adjusted, or may focus on high-confidence autonomous cycles as a basis for selecting training exemplars. The auxiliary function tracker thus facilitates real-time generation and periodic refinement of the heatmap, enabling data-driven decisions for route planning, vehicle configuration, autonomous function tuning, and targeted operator training.

A user interacting with the report—such as a maintenance technician, fleet manager, or autonomous system engineer—may view key performance indicators like the percentage of fully autonomous cycles, the frequency of emergency stops, or the rate of aborted functions. In some embodiments, the user may provide feedback or tag specific cycles for further analysis. For instance, if a particular cart collection required multiple manual overrides, the user may flag the instance for diagnostic review or assign it to a machine learning training dataset. In such embodiments, the one or more processors of the system receive the flag and generate a diagnostic review or apply the corresponding data to the machine learning training dataset.

Additionally or alternatively, the system module 330 may allow users to initiate queries or filter views based on specific cycle attributes, such as identifying all autonomous cycles that were interrupted within a given time range or searching for cycles where manual re-initiation was required. The system may support drill-down capabilities, enabling users to inspect individual cycles, review associated sensor data logs, or export data for third-party processing and analysis.

Ultimately, the generation and distribution of this report enables informed decision-making at multiple operational levels. It enhances visibility into the effectiveness of autonomous auxiliary functions, supports continuous improvement of vehicle behavior in the field, and provides accountability and traceability for both autonomous and manual system usage.

In some embodiments, the report generated from the auxiliary function tracker may be utilized to train a machine learning model configured to autonomously control the vehicle or one or more auxiliary subsystems. The one or more processors of the system—such as the one or more processors 315 of the data collection system 205 or a remote processing unit associated with the service manager 215—may extract structured auxiliary function datasets from the auxiliary function tracker, each dataset corresponding to a completed or attempted auxiliary function cycle. These datasets may include labeled cycle modes (e.g., autonomous, manual, interrupted), sensor time series data, environmental context, operator actions, and performance outcomes.

The one or more processors may then preprocess this data to remove anomalies, normalize signal values, and segment the data into meaningful feature vectors that represent the operational characteristics of the vehicle during each cycle. For example, the processors may extract features such as lift arm angular velocity, hydraulic pressure trends, joystick deflection magnitudes, and timing intervals between initiation and termination. These features may be associated with ground-truth labels derived from the cycle mode classifications recorded by the auxiliary function tracker.

Once prepared, the one or more processors may use these features and labels to train a supervised machine learning model (e.g., decision tree, random forest, support vector machine, deep neural network) configured to predict or replicate successful auxiliary function execution. In one embodiment, the model may be trained to predict the probability of autonomous cycle success based on initial sensor readings and environmental parameters, thereby allowing the system to decide whether to proceed autonomously or prompt for manual intervention. In another embodiment, the model may be trained to output control trajectories for actuators (e.g., lift arms, forks) that mimic high-confidence autonomous cycles observed in the field.

The machine learning model may be continuously updated over time as new reports are generated by the auxiliary function tracker. The one or more processors may schedule periodic retraining sessions using newly acquired data to refine the model's performance and adaptability. For example, if the report reveals that autonomous cycles fail more frequently in winter months due to icy conditions, the model may be retrained with seasonal sensor data to improve robustness.

Additionally, the processors may use performance metrics from the auxiliary function tracker—such as false positives, cycle aborts, or manual re-interventions—to evaluate the machine learning model's accuracy and recommend hyperparameter adjustments or architecture changes. This feedback loop between the auxiliary function tracker, report generation, and machine learning training infrastructure allows the system to incrementally improve the autonomy of the vehicle's auxiliary functions while maintaining transparency and control through interpretable performance data.

In some embodiments, the one or more processors of the system—such as the one or more processors 315 of the data collection system 205 or a processor associated with the autonomous system 235—may utilize a trained machine learning model to autonomously operate the vehicle or a subsystem thereof during execution of an auxiliary function. The processor may receive real-time telemetry data from the sensor array 350, including positional data, environmental conditions, actuator states, and operator interface activity. This incoming data may be formatted into feature vectors compatible with the structure of the machine learning model previously trained using historical data derived from the auxiliary function tracker.

For example, In some embodiments, the one or more processors are further configured to train a machine learning model using the auxiliary function dataset and the updated auxiliary function tracker. The auxiliary function dataset may include a collection of parameters corresponding to completed auxiliary function cycles, including control signals, sensor readings, positional data, timing information, environmental context, and metadata indicating operator input or system origination. The updated auxiliary function tracker may store cycle mode classifications derived from these parameters, including distinctions such as autonomous, manual, or hybrid execution modes (e.g., autonomous initiation with manual adjustment).

The training process involves using the auxiliary function dataset and the associated cycle mode classifications as labeled training data for a supervised learning algorithm. The one or more processors preprocess the dataset to normalize signal values, identify relevant features, and construct input vectors representing the operational state of the vehicle or subsystem during each completed auxiliary function cycle. The corresponding cycle mode serves as the ground-truth label for each training instance. Features may include, for example, lift actuator position profiles, hydraulic pressure curves, joystick deflection patterns, and proximity sensor activations, among others.

The trained machine learning model is configured to predict a cycle mode of a future auxiliary function cycle based at least in part on one or more parameters received in real-time. By analyzing new incoming telemetry or sensor data before or during the execution of an auxiliary function, the model may generate a predicted classification of the cycle mode—such as anticipating whether a manual adjustment will be required or if the cycle will complete autonomously. The system may use this prediction to trigger alerts, adjust control strategies, or initiate fallback logic based on anticipated intervention needs, thereby improving overall efficiency, safety, and autonomy of the auxiliary system.

Once trained, the machine learning model may be deployed on the same processing architecture or a connected computing node to execute real-time inference during vehicle operation. During execution of a new auxiliary function cycle, the one or more processors may receive telemetry and control data from the vehicle's sensor array and auxiliary subsystems, such as actuator positions, joystick input states, environmental sensor feedback, or system-level command originations. These real-time parameters are formatted into input vectors compatible with the trained model.

The model evaluates the incoming data and predicts a likely cycle mode for the ongoing or upcoming auxiliary function—such as a fully autonomous cycle, a manual cycle, or a hybrid scenario involving interruption or override. Based on the predicted cycle mode, the one or more processors may dynamically adjust one or more control strategies. For example, if the model predicts a high likelihood of manual intervention, the system may preemptively reduce actuator speeds, alert the operator, or reconfigure system thresholds to support safer manual override. Alternatively, if a fully autonomous cycle is predicted, the system may commit to the autonomous trajectory with increased confidence and reduced operator supervision.

Additionally, the predicted cycle mode may be logged into the auxiliary function tracker alongside actual outcomes to provide feedback for continued model refinement. In some embodiments, discrepancies between predicted and actual cycle modes may be used to identify edge cases, update model confidence metrics, or flag cycles for future retraining, thereby supporting continuous learning and improvement of auxiliary function autonomy.

Based on the real-time feature inputs, the machine learning model executed by the processor may generate a set of predictive outputs corresponding to target actuator positions, control sequences, or operational decisions. For example, during a cart collection event, the model may predict an optimal lift arm trajectory and fork actuation pattern that avoids known obstructions or compensates for misaligned carts, as previously learned from similar cycles. The one or more processors 315 may then generate control signals based on these predictions, such as actuator movement commands, valve control signals, or timing signals for motor or hydraulic engagement.

The processor may transmit these control signals to one or more components of the auxiliary system 230 of the vehicle, including hydraulic controllers, drive units, or motor drivers, to physically actuate the predicted movements. For instance, the processor may send a command to extend the lift arm at a specified rate while simultaneously adjusting the fork angle to ensure a smooth cart pickup. These adjustments may be computed in real time, with the processor continually comparing incoming sensor feedback against model-predicted outcomes and refining control signals accordingly.

Additionally, the processor may autonomously adjust operating parameters of the vehicle based on model outputs. These operating parameters may include lift speed, applied hydraulic pressure, actuator acceleration limits, or environmental tolerances (e.g., minimum clearance thresholds). For example, if the machine learning model detects that the current lift sequence resembles a past cycle that required slower movement due to cart instability, the processor may transmit a control signal to reduce the lift arm velocity to improve safety and reliability.

In some embodiments, the processor may also use the model to predict when manual intervention is likely and may preemptively notify the operator or temporarily switch to a semi-autonomous mode to await further input. This dynamic interaction between the machine learning model and real-time vehicle control systems enables a fluid transition between autonomous and manual operations while maintaining system awareness and operational continuity.

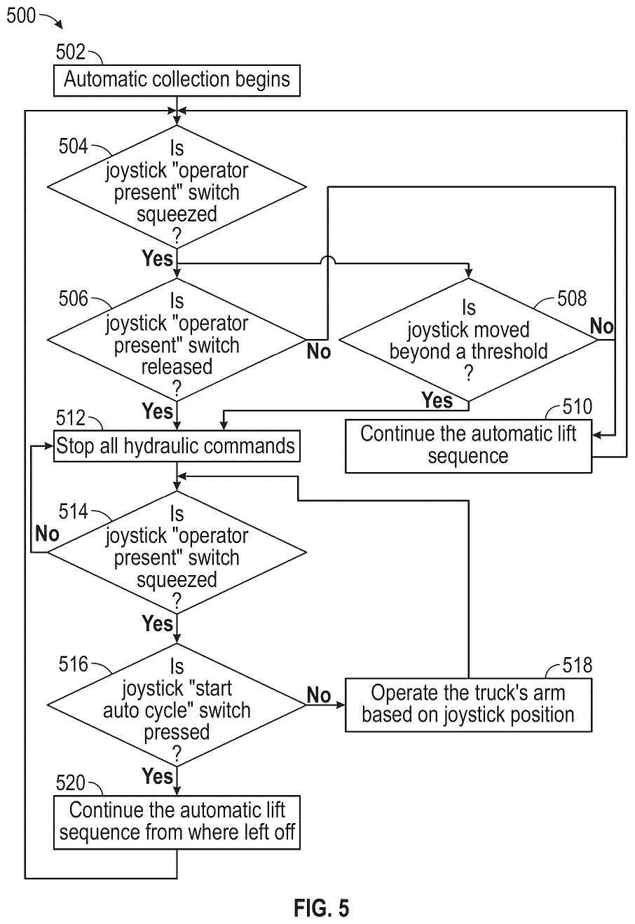

Turning now to FIG. 5, a flowchart of a method 500 (e.g., a computer-implemented method) is shown for controlling the execution of an automatic lift sequence performed by an auxiliary device of a vehicle, such as a refuse cart lift system. The method 500 illustrates one example control process, and it should be understood that variations, substitutions, or alternative implementations may be used depending on the vehicle configuration, sensor suite, and control interface. The method 500 begins, in some embodiments, at step 502, where the vehicle controller initiates the automatic lift sequence. The initiation may occur based on a manual input—such as a user pressing a physical or digital “start auto cycle” button—or automatically based on a trigger event. For example, the system may detect that a refuse cart is within a predefined engagement zone using proximity sensors, vision-based alignment, or GPS geofencing, and subsequently auto-initiate the lift sequence without direct operator input.

At step 504, the controller determines whether a “joystick operator present switch” is currently pressed. In the illustrated embodiment, the joystick operator present switch serves as a safety interlock or acknowledgment mechanism to ensure that an operator is engaged and monitoring the cycle. This switch may be integrated into the joystick as a pressure-sensitive grip sensor or trigger button. However, the concept of an operator-present indication is not limited to a joystick interface. Alternative implementations may use a seat pressure switch to detect operator presence, a foot pedal to confirm engagement, or even a computer vision system that confirms the operator's face or posture. In semi- or fully-autonomous vehicles, an “operator present” determination may also derive from biometric readings, head position sensors, or authenticated control login activity. Any of these alternative embodiments may be used in place of or in addition to the joystick operator present switch, depending on the specific system implementation.

If, at step 504, the controller determines that the operator present switch is pressed, the method proceeds to step 506 to check whether the operator present switch is subsequently released. If the switch remains pressed, the method advances to step 510, where the automatic lift sequence continues uninterrupted. The controller may then cycle back to step 504 to perform continual monitoring of the operator presence state.

In parallel, the method also proceeds from step 504 to step 508, where the controller checks whether the joystick or other human-machine interface (HMI) has been moved beyond a predefined threshold. This threshold may correspond to a physical displacement, analog signal amplitude, or digital command state indicating operator override. If no significant movement is detected—meaning the operator has not attempted to manually intervene—the method again proceeds to step 510, and the automatic lift sequence continues.

However, if at step 506 the operator present switch is released, or at step 508 the joystick is moved beyond the threshold, the controller recognizes this as a manual interruption or override, and the method proceeds to step 512. At step 512, the vehicle controller transmits instructions to immediately halt all active commands to the auxiliary device (e.g., stopping all hydraulic or electronic actuations). This step serves as a safety and control boundary, allowing the operator to intervene and take direct control without conflict between automated and manual commands.

Following interruption, the method advances to step 514, where the controller evaluates whether the operator present switch has been re-engaged. If not, the system remains in the paused or interrupted state, returning to step 512. If the switch is pressed again, the controller advances to step 516, where it evaluates whether the operator has activated a “start automatic cycle” switch, signaling an intention to resume autonomous control.

If the controller does not detect a press of the start automatic cycle switch at step 516, the method proceeds to step 518. Here, the vehicle operates in a manual control mode, with the controller transmitting instructions to actuate the auxiliary device based directly on the current joystick position. This allows the operator to complete the lift cycle manually, which may be necessary if the cart is misaligned, obstructed, or otherwise not safely collectable through autonomous execution.

Alternatively, if at step 516 the start automatic cycle switch is pressed, the method proceeds to step 520. At this stage, the vehicle controller issues commands to resume the automatic lift sequence from the point at which it was previously interrupted in step 512. This may involve resynchronizing actuator positions, confirming environmental safety, and re-engaging system-level timing protocols. The process then loops back to step 504 for continued monitoring.

It should be understood that method 500 may include additional, fewer, or alternative steps depending on the system configuration. For example, the controller may additionally log operator interventions, record timing between interruption and resumption, or count the number of manual versus automatic transitions for reporting or training purposes. These data points may be stored in the auxiliary function tracker and used to determine the cycle mode (e.g., autonomous with manual interruption, manual cycle, autonomous cycle with manual completion). Similarly, the system may incorporate voice control interfaces, touchscreen prompts, haptic feedback, or other multimodal inputs in place of traditional switches or joysticks.

The auxiliary function tracker operates in conjunction with the steps of method 500 by recording, classifying, and contextualizing the execution of the auxiliary function—such as the lift sequence illustrated in FIG. 5—based on how it was initiated, adjusted, and completed. Throughout method 500, the auxiliary function tracker continuously monitors and logs relevant events and decision points, enabling comprehensive classification of the cycle mode associated with each auxiliary function instance.

At the initiation of the automatic lift sequence in step 502, the auxiliary function tracker receives metadata indicating how the sequence was started. For example, if the initiation was triggered by a press of the “start auto cycle” button linked to the autonomous system 235, the tracker records the initiation mode as autonomous. Alternatively, if the operator manually moved the joystick to begin lifting the cart, the initiation mode is recorded as manual. This classification is stored as the first parameter in the cycle mode profile.

As method 500 progresses through step 504, 506, 508, the auxiliary function tracker observes whether the operator present switch remains engaged and whether the joystick or other human-machine interface has been moved beyond a predefined threshold. If no such movement is detected and the automatic lift sequence proceeds uninterrupted, the tracker logs the adjustment mode as autonomous. However, if the joystick is moved, or if the operator present switch is released (thereby triggering a manual takeover at step 512), the tracker records the adjustment mode as manual, capturing the occurrence of an operator intervention.

In subsequent steps (e.g., step 514, 516, 518, 520) the auxiliary function tracker continues monitoring for further manual or autonomous actions. If the operator completes the lift manually by controlling the auxiliary device through the joystick at step 518, the tracker records the termination mode as manual. Conversely, if the operator re-engages the operator present switch and presses the start auto cycle switch (step 516), thereby resuming the automatic lift at step 520, the tracker logs the termination as autonomous. This final classification completes the cycle mode entry for the particular auxiliary function event.

Upon conclusion of the lift sequence, the auxiliary function tracker aggregates the logged data—initiation mode, adjustment mode, and termination mode—into a structured cycle record and stores it in the auxiliary function database 335. For example, if a lift sequence was autonomously initiated, briefly adjusted manually due to a cart misalignment, and then automatically completed, the tracker would assign the cycle mode classification: autonomous initiation, manual adjustment, autonomous termination. These entries may be tagged with timestamps, operator ID, environmental context, and GPS location to support further analytics.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” etc.) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration.

In some embodiments, particular processes and methods (e.g., computer-implemented methods) may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may include or may be embodied as a computer-readable, non-transitory storage medium configured to retain program instructions and application logic. The memory may be or include volatile memory or non-volatile memory and may include database components, object code components, script components, or any other type of information structure for supporting the various activities and information structures described in the present disclosure.

The memory may be communicably connected to the processor via a processing circuit and may include computer code for executing (e.g., by the processing circuit or the processor) one or more of the computer-implemented methods and/or processes described herein. In one embodiment, the entire operating logic for a system described herein is stored and maintained in a computer-readable, non-transitory storage medium housed within a vehicle-mounted or cloud-based computing system.

The present disclosure contemplates computer-implemented methods, systems, and program products implemented using a computer-readable, non-transitory storage medium for accomplishing various operations. Such a medium may contain software instructions, data structures, configurations, or runtime environments accessible by a general-purpose or special-purpose computer. A computer-readable, non-transitory storage medium can include but is not limited to RAM, ROM, EPROM, EEPROM, flash memory, optical disk storage, magnetic disk storage, or any other physical medium configured to store computer-readable instructions.

Machine-executable instructions residing on a computer-readable, non-transitory storage medium may be configured to cause a general-purpose computer, special-purpose computer, or special-purpose processing machines to perform the functions and operations described herein. These media may support standalone applications or cloud-based services, and combinations of local and distributed computing environments. For example, telemetry-based control systems, heatmap generation tools, and machine learning inference routines may all be executed using data accessed from one or more computer-readable, non-transitory storage media.

Although the figures and description may illustrate a specific order of computer-implemented method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described computer-implemented methods could be accomplished with standard programming techniques with rule-based logic and other logic to accomplish the various connection steps, processing steps, comparison steps, and decision steps.

The construction and arrangement of the refuse vehicle as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosures. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A method comprising:
receiving, by one or more processors, an auxiliary function dataset including one or more parameters corresponding to a completed auxiliary function cycle;
determining, by the one or more processors, a cycle mode of the completed auxiliary function cycle based at least in part on the one or more parameters; and
updating, by the one or more processors, an auxiliary function tracker based at least in part on the determined cycle mode of the completed auxiliary function cycle.

2. The method of claim 1, further comprising:
transmitting, by the one or more processors to a user device, instructions to present for display the updated auxiliary function tracker on a display of the user device.

3. The method of claim 1, further comprising receiving, by the one or more processors from a sensor array, the auxiliary function dataset, the auxiliary function dataset including an indication of a manual adjustment of an autonomous execution of the completed auxiliary function cycle.

4. The method of claim 1, wherein the cycle mode includes one of an autonomous cycle, an autonomous cycle with manual interruption, an autonomous cycle with manual completion, and a manual cycle.

5. The method of claim 1, wherein the one or more parameters include one or more of interruption type, completion status, error state flag, re-initiation, cart alignment, obstruction presence, manual override duration, control system confidence level, or learning mode.

6. The method of claim 1, further comprising:
generating, by the one or more processors, a heatmap based at least in part on the auxiliary function tracker, wherein the heatmap indicates geographic regions associated with completed auxiliary function cycles, and wherein the heatmap is segmented by cycle mode and the one or more parameters of the auxiliary function dataset.

7. The method of claim 1, further comprising:
training, by the one or more processors, a machine learning model using the auxiliary function dataset and the updated auxiliary function tracker, wherein the machine learning model is configured to predict a cycle mode of a future auxiliary function cycle based at least in part on the one or more parameters.

8. A refuse vehicle comprising:
one or more processors; and
a computer-readable, non-transitory storage medium comprising instructions that when executed by the one or more processors cause the one or more processors to execute a method comprising:
receiving an auxiliary function dataset including one or more parameters corresponding to a completed auxiliary function cycle;
determining a cycle mode of the completed auxiliary function cycle based at least in part on the one or more parameters; and
updating an auxiliary function tracker based at least in part on the determined cycle mode of the completed auxiliary function cycle.

9. The refuse vehicle of claim 8, the method further comprising:
transmitting, by the one or more processors to a user device, instructions to present for display the updated auxiliary function tracker on a display of the user device.

10. The refuse vehicle of claim 8, the method further comprising:
receiving, by the one or more processors from a sensor array, the auxiliary function dataset, the auxiliary function dataset including an indication of a manual adjustment of an autonomous execution of the completed auxiliary function cycle.

11. The refuse vehicle of claim 8, wherein the cycle mode includes one of an autonomous cycle, an autonomous cycle with manual interruption, an autonomous cycle with manual completion, and a manual cycle.

12. The refuse vehicle of claim 8, wherein the one or more parameters include one or more of interruption type, completion status, error state flag, re-initiation, cart alignment, obstruction presence, manual override duration, control system confidence level, or learning mode.

13. The refuse vehicle of claim 8, the method further comprising:
generating, by the one or more processors, a heatmap based at least in part on the auxiliary function tracker, wherein the heatmap indicates geographic regions associated with completed auxiliary function cycles, and wherein the heatmap is segmented by cycle mode and the one or more parameters of the auxiliary function dataset.

14. The refuse vehicle of claim 8, the method further comprising:
training, by the one or more processors, a machine learning model using the auxiliary function dataset and the updated auxiliary function tracker, wherein the machine learning model is configured to predict a cycle mode of a future auxiliary function cycle based at least in part on the one or more parameters.

15. A computer-readable, non-transitory storage medium comprising instructions that when executed by one or more processors cause the one or more processors to execute a method comprising:
receiving an auxiliary function dataset including one or more parameters corresponding to a completed auxiliary function cycle;
determining a cycle mode of the completed auxiliary function cycle based at least in part on the one or more parameters; and
updating an auxiliary function tracker based at least in part on the determined cycle mode of the completed auxiliary function cycle.

16. The computer-readable, non-transitory storage medium of claim 15, the method further comprising:
transmitting, by the one or more processors to a user device, instructions to present for display the updated auxiliary function tracker on a display of the user device.

17. The computer-readable, non-transitory storage medium of claim 15, the method further comprising:
receiving, by the one or more processors from a sensor array, the auxiliary function dataset, the auxiliary function dataset including an indication of a manual adjustment of an autonomous execution of the completed auxiliary function cycle.

18. The computer-readable, non-transitory storage medium of claim 15, wherein the one or more parameters include one or more of interruption type, completion status, error state flag, re-initiation, cart alignment, obstruction presence, manual override duration, control system confidence level, or learning mode.

19. The computer-readable, non-transitory storage medium of claim 15, the method further comprising:
generating, by the one or more processors, a heatmap based at least in part on the auxiliary function tracker, wherein the heatmap indicates geographic regions associated with completed auxiliary function cycles, and wherein the heatmap is segmented by cycle mode and the one or more parameters of the auxiliary function dataset.

20. The computer-readable, non-transitory storage medium of claim 15, the method further comprising:
training, by the one or more processors, a machine learning model using the auxiliary function dataset and the updated auxiliary function tracker, wherein the machine learning model is configured to predict a cycle mode of a future auxiliary function cycle based at least in part on the one or more parameters.
